(19) United States
(12) Patent Application Publication
(10) Pub. No.: US 2025/0151090 A1
(43) Pub. Date: May 8, 2025

(54) WIRELESS TELECOMMUNICATIONS APPARATUSES AND METHODS

(71) Applicant: Sony Group Corporation, Tokyo (JP)

(72) Inventors: Vivek SHARMA, Basingstoke (GB); Kazuyuki SHIMEZAWA, Basingstoke (GB)

(73) Assignee: Sony Group Corporation, Tokyo (JP)

(21) Appl. No.: 18/839,027

(22) PCT Filed: Feb. 14, 2023
(86) PCT No.: PCT/EP2023/053590

§ 371 Date: Aug. 16, 2024

(30) Foreign Application Priority Data
Mar. 1, 2022 (EP) 22159546.5

(51) Int. Cl. H04W 72/25; H04W 72/541

(52) U.S. Cl. CPC H04W 72/25; H04W 72/541

(57) ABSTRACT

A wireless telecommunications apparatus for use in a wireless telecommunications network is provided. The wireless telecommunications apparatus comprises communication circuitry configured to transmit or receive a wireless signal over a sidelink interface using one or more unlicensed resources; and control circuitry configured to determine whether there is a preference not to use the one or more unlicensed resources, and if there is a preference not to use the one or more unlicensed resources, control the communication circuitry to transmit a signal to the wireless telecommunications network indicating the preference not to use the one or more unlicensed resources.

### BACKGROUND

### Field of the Disclosure

The present disclosure relates to wireless telecommunications apparatuses and methods.

### Description of the Related Art

The “background” description provided is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present disclosure.

Recent generation mobile telecommunication systems, such as those based on the 3rd Generation Partnership Project (3GPP®) defined Universal Mobile Telecommunications System (UMTS), Long Term Evolution (LTE) and 5G New Radio (NR) architectures, are able to support a wider range of services than simple voice and messaging services offered by previous generations of mobile telecommunication systems. For example, with the improved radio interface and enhanced data rates provided by LTE and NR systems, a user can experience high data rate applications such as mobile video streaming and mobile video conferencing that would previously only have been available via a fixed line data connection.

In addition to supporting these kinds of more sophisticated services and devices, it is also proposed for newer generation mobile telecommunication systems such as NR to support less complex services and devices which make use of the reliable and wide ranging coverage of newer generation mobile telecommunication systems without necessarily needing to rely on the high data rates available in such systems. For example, a less complex device may be a tiny device equipped with sensors and a small battery capacity. Such a less complex device needs to transmit the sensor data at a typically infrequent and/or low data rate.

The demand to deploy such networks is therefore strong and there is a desire to improve the coverage area and flexibility of these networks, i.e. geographic locations where access to the networks is possible. One way of doing this is by enabling so-called sidelink communication between user equipment of such networks. Such sidelink communication allows signals to be transmitted directly between user equipment without using an intermediary base station. However, it remains desirable to improve existing sidelink capability.

### SUMMARY

The present disclosure is defined by the claims.

### BRIEF DESCRIPTION OF THE DRAWINGS

Non-limiting embodiments and advantages of the present disclosure are explained with reference to the following detailed description taken in conjunction with the accompanying drawings, wherein:

FIG. 1 schematically represents some elements of an LTE-type wireless telecommunications system;

FIG. 2 schematically represents some elements of an NR-type wireless telecommunications system;

FIG. 3 schematically represents some components of the wireless telecommunications system shown in FIG. 2 in more detail;

FIGS. 4A and 4B schematically show mode 1 and mode 2 allocation of unlicensed sidelink resources;

FIG. 5 shows an example method of adjusting allocated unlicensed sidelink resources in mode 2;

FIG. 6 shows an example method of adjusting allocated unlicensed sidelink resources in mode 1;

FIGS. 7A and 7B show first example methods of controlling a wireless telecommunications apparatus; and

FIG. 8 shows a second example method of controlling a wireless telecommunications apparatus.

Like reference numerals designate identical or corresponding parts throughout the drawings.

### DETAILED DESCRIPTION OF THE EMBODIMENTS

### Long Term Evolution (LTE) Wireless Communications System

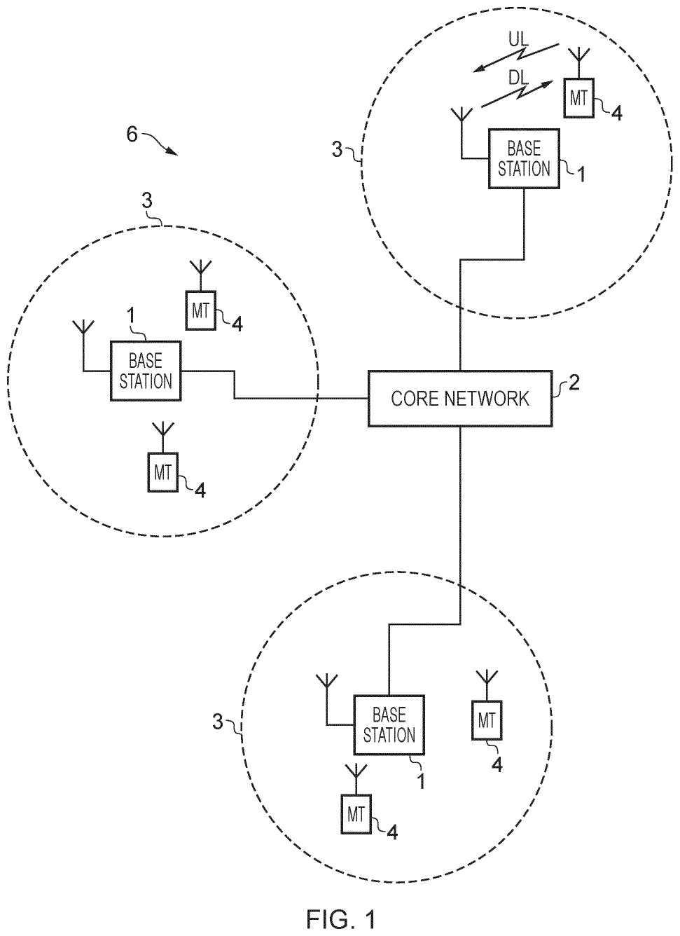

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP body, and also described in many books on the subject, for example, Holma, H. and Toskala, A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4.

Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink (DL). Data is transmitted from communications devices 4 to the base stations 1 via a radio uplink (UL). The core network 2 routes data to and from the communications devices 4 via the respective base stations 1 and provides functions such as authentication, mobility management, charging and so on. A communications device may also be referred to as a mobile station, user equipment (UE), user terminal, mobile radio, terminal device and so forth.

Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

A base station, which is an example of network infrastructure equipment, may also be referred to as a transceiver station, nodeB, e-nodeB, eNB, g-nodeB, gNB and so forth (note g-nodeB and gNB are related to 5G New Radio-see below). In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

In the present disclosure, any apparatus (e.g. communications device, infrastructure equipment and the like) which transmits and/or receives wireless telecommunications signals in any of the exemplified wireless telecommunication networks/systems may be referred to generally as a wireless telecommunications apparatus.

### 5G New Radio (NR) Wireless Communications System

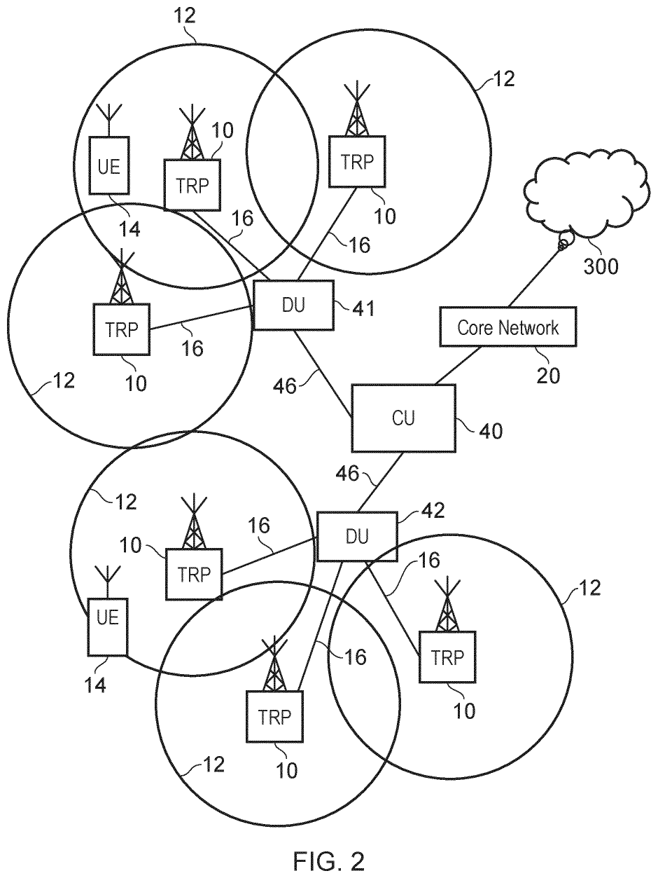

An example configuration of a wireless communications network which uses some of the terminology proposed for NR is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to a core network 20 which may contain all other functions required for communicating data to and from the wireless communications devices and the core network 20. The core network 20 may be connected to other networks 300.

The elements of the wireless access network shown in FIG. 2 may operate in a similar way to corresponding elements of an LTE network as described with regard to the example of FIG. 1. It will be appreciated that operational aspects of the telecommunications network represented in FIG. 2 and of other networks discussed herein in accordance with embodiments of the disclosure which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated, therefore, that operational aspects of an NR network (for example in relation to specific communication protocols and physical channels for communicating between different elements) may be different to those known from LTE or other known mobile telecommunications standards. However, it will also be appreciated that each of the core network component, base stations and communications devices of an NR network will be functionally similar to, respectively, the core network component, base stations and communications devices of an LTE wireless communications network.

In terms of broad top-level functionality, the core network 20 connected to the NR telecommunications system represented in FIG. 2 may be broadly considered to correspond with the core network 2 represented in FIG. 1, and the central unit 40 and associated DUs 41, 42/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the CU 40, DUs 41, 42 and/or TRPs 10. Communications devices 14 are represented in FIG. 2 within the coverage area of respective communication cells 12. These communications devices 14 may thus exchange signalling with the CU 40 via the TRP 10 associated with their respective communication cells 12.

It will further be appreciated that FIG. 2 represents merely one example of a proposed architecture for an NR-based telecommunications system in which approaches in accordance with the principles described herein may be adopted, and the functionality disclosed herein may also be applied in respect of wireless telecommunications systems having different architectures.

Thus certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a CU 40, DU 41, 42 and/or TRP 10 of the kind shown in FIG. 2 which is adapted to provide functionality in accordance with the principles described.

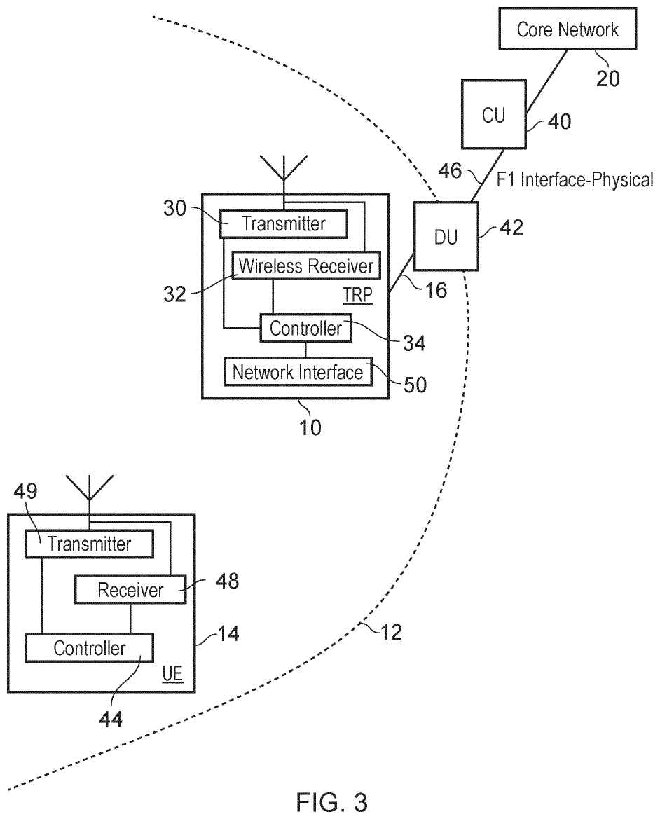

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which is configured to control the transmitter 30 and the receiver 32 to transmit radio signals to and receive radio signals from one or more UEs 14 within a cell 12 formed by the TRP 10. As shown in FIG. 3, an example UE 14 is shown to include a corresponding wireless transmitter 49, wireless receiver 48 and a controller or controlling processor 44 which is configured to control the transmitter 49 to transmit signals representing uplink data to the wireless communications network via the wireless access interface formed by the TRP 10 and the receiver 48 to receive downlink data as signals transmitted by the transmitter 30.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance, for example, with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473 and, for example, may be formed from a fibre optic or other wired high bandwidth connection. In one example, the connection 16 from the TRP 10 to the DU 42 is fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

### NR Sidelink (SL) Communication

For NR, sidelink (SL) communication has been specified to allow direct communication between UEs (that is, so communication does not have to go through an intermediary base station). For NR sidelink, there are two different types of resource allocation (known as resource allocations modes). These are sidelink resource allocation mode 1 and sidelink resource allocation mode 2. These are specified in 3GPP Release-16 for licensed mode operation. The term “resource” here means time and/or frequency communication resources of a 3GPP radio frame, for example. Resources may be allocated by mode 1 or mode 2 in a licensed band (which is only available for use by 3GPP devices, for example) or unlicensed band (which is available for use by any device, including 3GPP devices and other devices, for example). An unlicensed band may be referred to as a shared band or shared spectrum.

Mode 1 involves a gNB granting resources for SL operation. The granted resources may be either in a licensed or unlicensed band.

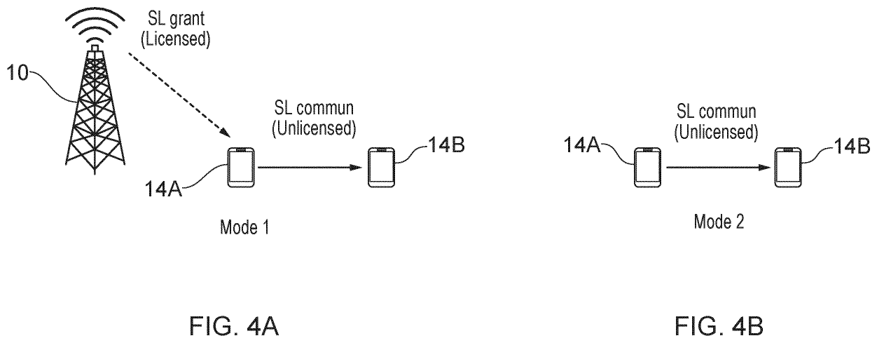

FIG. 4A shows an example of mode 1. Here, a gNB 10 operates with UE 14A and/or UE 14B in its cell in a licensed band and grants resources to the UE 14A and/or UE 14B for SL communication between the UEs 14A and 14B in an unlicensed band.

Mode 2 operates using a resource pool. The resource pool is allocated to the UE 14A and/or UE 14B in advance (so the specific SL resource grant of mode 1 is not required). The resource pool is allocated by a gNB or is pre-configured at the UE 14A and/or 14B. Pre-configured resource pool(s) include those saved used for emergency communication and/or for when a UE is out of coverage of the network, for example.

FIG. 4B shows an example of mode 2. Here, SL communication between the UEs 14A and 14B again takes place in an unlicensed band and the UE 14A and/or UE 14B is informed of the resource pool in advance, for example via system information or via direct signalling from a gNB. For SL transmission, a transmitting UE (Tx UE, e.g. UE 14A in FIG. 4B) selects a SL resource within the resource pool based on a specific sensing procedure. The sensing procedure is performed to reduce a probability of collision with other UE(s) during SL communication with the receiving UE (Rx UE, e.g. UE 14B in FIG. 4B).

For the sensing procedure for resource pool(s) in the licensed band, for example, the Tx and/or Rx UE monitors the control information of surrounding UEs (to check SL resource utilisation status including SL resource reservation status) and measures the Received Signal Strength Indicator (RSSI) or Reference Signal Received Power (RSRP) of transmissions using resources within the resource pool indicated by the control information to determine which resources are likely to be less susceptible to collision/interference. For example, an RSRP measurement may be performed on resource elements of a demodulation reference signal of a physical sidelink shared channel (PSSCH) which is indicated by the control information (this measurement is referred to as PSSCH-RSRP). To realise this, for mode 2, a UE can reserve future SL resource(s) via the control information, for example.

For the sensing procedure for resource pool(s) in the unlicensed band, for example, monitoring control information of other UEs to then measure the PSSCH-RSRP is not appropriate for collision/interference alleviation, since the collision/interference may come from other (e.g. non-3GPP) devices for which control information cannot be decoded. In this case, the Tx and/or Rx UE measures the RSSI within a specific resource of each of the allocated SL resource pool(s), for example (this measurement is referred to as SL-RSSI).

There may also be provided a temporal window in which the Tx UE makes no transmission. This temporal window is a predetermined time period (e.g. defined by a start time, end time and/or duration) known to the Rx UE and thus allows the Rx UE to know that any RSRP or RSSI measurement made on the allocated resource pool(s) during that window is an interference signal. Any detected interference signal can then be reported back to the Tx UE or gNB (e.g. as part of IUC-see below). The Tx UE then transmits to the Rx UE using resource(s) of resource pool(s) for which no interference signal was detected. This may apply to either the licensed or unlicensed sensing procedure.

PSSCH-RSRP and SL-RSSI are discussed in Annex 3 [2].

In 3GPP Release-17, Inter UE Coordination (IUC) was specified for licensed band mode 2 operation (see Annex 1 [3]). This was to address that fact that the full set of resources of a resource pool allocated by the gNB for SL communication may not be available to a specific Tx UE for SL communication due to interference from other UEs operating in the vicinity. For example, the IUC may involve the transmission of information from the Rx UE to the Tx UE to inform the Tx UE of preferred or non-preferred resources or resource pools for reception at the Rx UE. For example, if the Rx UE detects interference on one resource pool, the UE may indicate this to be a non-preferred resource pool. On the other hand, if the Rx UE detects no interference on another resource pool, the UE may indicate this to be a preferred resource pool. IUC may be also be used for mode 1 (e.g. to indicate preferred or non-preferred granted SL resources at the Rx UE).

The use of IUC in this way, however, is most appropriate for operation in licensed bands, in which only interference/collision with respect to other 3GPP devices needs to be considered (since only 3GPP devices can use these licensed bands). Operation in unlicensed bands, however, may suffer interference/collision with respect to a much wider range of devices (since any device, including non-3GPP devices, can use unlicensed bands). Thus, IUC in its current form may not be suitable for addressing interference/collision in unlicensed operations.

In more detail, unlicensed SL communication may suffer from a so-called “hidden node” problem. The hidden node is, for example, a non-3GPP device transmitting signals in the unlicensed band which interferes with the SL signals (and vice versa—the transmitted 3GPP SL signals may also interfere with signals transmitted by the non-3GPP device). For UEs operating in mode 2, for example, the whole or a part of a resource pool allocated by a gNB may become unsuitable for use in SL communication due to the presence of such hidden nodes.

Such interference may be detected by UEs involved in the SL operation based on failed Tx/Rx attempts between the UEs. Alternatively, or in addition, these UEs may perform SL-RSSI measurements (as explained above) or wideband channel measurements

To report interference to the gNB, the UE 14A or 14B may move from an RRC_IDLE/INACTIVE state to an RRC_Connected state. Alternatively, if the UE is in an RRC_INACTIVE state, it may report the interference using an RRC message while performing small data transmission (SDT) and staying in the RRC_INACTIVE state. For example, the UE may be configured such that, when in an RRC_INACTIVE state performing SDT, it is allowed to transmit the interference reporting information to the gNB in an RRC message.

Currently, the known SidelinkUEInformationNR RRC message (shown in Annex 2 [4]) is supported in NR (3GPP Release-16) and is sent by a UE when an RRC connection is established.

In an embodiment, the interference reporting information is comprised in the SidelinkUEInformationNR RRC message. Due to the nature of interference in an unlicensed band (e.g. an inability to stop the source of the interference), there may be a need to transmit the interference reporting information immediately and not wait for the next time an RRC connection is established in the usual way. Thus, rather than waiting for the usual Non-Access Stratum (NAS) trigger to initiate an RRC connection, it may be desirable for a UE in RRC_IDLE/RRC_INACTIVE mode to transition to RRC_Connected mode (or to transition from RRC_IDLE mode to RRC_INACTIVE mode for the above-mentioned SDT-based solution) based on, for example, one or more triggers indicated by sidelink information collected over an SL interface operating between the UE and another UE in an unlicensed band.

In an embodiment, the UEs 14A and/or 14B are thus configured to transition to RRC_Connected or RRC_INACTIVE mode immediately if sidelink information related to an SL interface operating in an unlicensed band between the UEs (referred to as SL-unlicensed (SL-U)) indicates SL communication has been affected (e.g. by interference) and cannot be corrected by existing mechanisms such as IUC. This allows the SidelinkUEInformationNR message comprising the interference reporting information to be transmitted.

In an example, the sidelink information may comprise an indicator which takes a predetermined value when SL-U interference is preventing SL communication from occurring successfully. This may occur, for example, if the Rx UE cannot identify sufficient preferred resources (e.g. at least a predetermined number of preferred resource pools), if the Rx UE identifies too many non-preferred resources (e.g. at least a predetermined number of non-preferred resource pools) and/or if Tx/Rx failure occurs more than a predetermined number of consecutive times.

In an embodiment, the interference reporting information comprises new information which is reported for SL-U. For example, currently, interested frequencies (that is, frequencies over which a UE may transmit an SL communication) are reported to the gNB in the SidelinkUEInformationNR message. However, reporting of only one frequency is permitted at a time (since only one entry can be included in the sl-TxInterestedFreqList field of the SidelinkUEInformationNR message). In an embodiment, sl-TxInterestedFreqList is modified and/or new field(s) are introduced to enable a UE to simultaneously report a plurality of interested frequencies for SL transmission and/or to report one or more frequencies on which interference is detected. This allows the gNB to then adjust the configured resource pool(s) accordingly (e.g. to activate resource pool(s) with the interested frequencies and deactivate resource pool(s) with the frequencies in which interference issues are detected). A UE may determine a frequency to be an interested frequency if, for example, it detects there is no interference on that frequency. It is noted the term “frequency” here refers to a carrier frequency as identified, for example, by an appropriate absolute radio-frequency channel number (ARFCN).

Currently, only one bandwidth part (BWP) can be configured for each frequency for SL communication. In an embodiment, with SL-U, a plurality of BWP may be configured for each frequency for SL communication. This increases the flexibility of the resource pool selection, since different resource pools using the same frequency may be associated with different respective active BWPs. A maximum number of the configurable BWPs may be different among frequency bands (e.g. 5 GHz band, 6 GHz band and 60 GHz band) or frequency ranges (e.g. FR1 and FR2).

With current approaches, sidelink Tx and/or Rx failure causes which are reported to the gNB in the SidelinkUEInformationNR message include radio link failure (RLF) and access stratum (AS) configuration failure. These are indicated in the sl-Failure field as values rlf and configFailure, respectively. In an embodiment, additional value(s) may be added to indicate when a sidelink Tx and/or Rx failure is the result of interference. For example, if a UE performs listen before talk (LBT) on its active SL-U resource pool(s) but is unable to proceed with a transmission due to interference detected by the LBT procedure, an additional value may be added to the si-Failure field (e.g. a value lbt) indicating that this was the cause of the communication failure. The gNB may then perform suitable resource pool adjustment to try to alleviate this.

Thus, in an example, a gNB may be alerted to a SL-U communication failure by receiving, from a UE, a SidelinkUEInformationNR message indicating a one or more interested frequencies and/or one or more frequencies on which the UE has detected interference (e.g. as identified in the sl-TxInterestedFreqList field) and an indication that communication failure has occurred due to interference (e.g. as identified in the sl-Failure field). The gNB, in response, can then adjust the resource pool(s) allocated to the UE for SL-U communication by, for example, allocating different resource pool(s) to the UE which use different frequencies to those indicated in the SidelinkUEInformationNR message.

In an example, the indication that communication failure has occurred is optional. If no such indication is included but, for example, the UE indicates in the SidelinkUEInformationNR message one or more frequencies on which the UE has detected interference, this may still be used by the gNB to adjust the allocated resource pool(s) to reduce the likelihood of interference (e.g. by allocating resource pool(s) to the UE which do not use the indicated frequencies), even though a communication failure has not yet occurred. This helps to pre-emptively reduce the risk of later communication failure due to interference.

With the present technique, the existing SidelinkUEInformationNR RRC message may thus be adapted to include additional information usable by the gNB to determine whether there is likely to be interference for SL-U communication for a given UE and to adjust the resource pool(s) allocated to that UE accordingly. In this case, for example, the reporting of interference at steps 508 and/or 509 comprises transmission of the adapted SidelinkUEInformationNR RRC message. Other messages may also be used to report the interference. For example, in another embodiment, the LTE indevicecoexistence RRC message, which is defined for the Uu interface to report coexistence issues inside the UE due to the presence of different RF (radio frequency) units (e.g. WiFi, Bluetooth, GNSS, and the like) causing interference to LTE transmission and/or reception, is enhanced for SL operation and includes the interference information (e.g. interested frequencies, frequencies on which interference is detected and/or a Tx/Rx failure reason) described above. Alternatively, an RRC UEAssistanceInformation message is suitably modified to include the interference information described above.

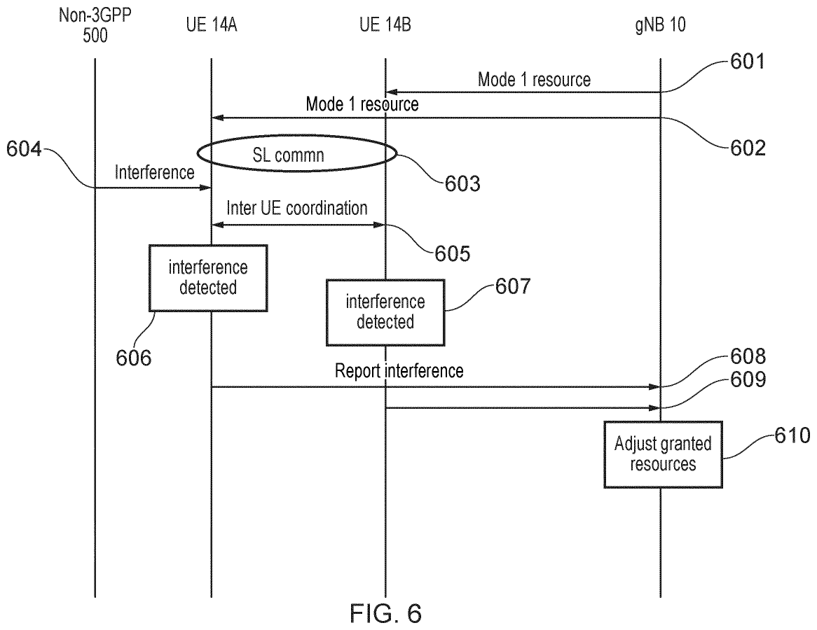

The present technique is not limited to mode 2 operation but may also be used with mode 1 operation. As discussed, in mode 1 operation, the gNB grants specific SL resources to a specific UE. It is therefore desirable for the gNB to know whether those granted resources are subject to interference so that, if necessary, different resources with less interference can be granted to the UE instead. UE(s) may again notify the gNB of interference by, for example, transmitting UE assistance information to the gNB. This is illustrated in FIG. 6.

At steps 601 and 602, gNB 10 grants UE 14B and UE 14A with unlicensed resources for mode 1 SL operation. The UEs 14A and 14B are thus able to perform SL communication with each other using the granted resources at step 603.

While SL communication is ongoing, or even before the SL communication has started, one of the UEs (in this case, UE 14A) experiences interference at its receiver. This is step 604. In response to this, at step 605, this UE (UE 14A) performs coordination with the other UE (UE 14B) based on, for example, the above-mentioned 3GPP Release-17 IUC procedure.

As a result of the IUC procedure, the UEs 14A and 14B attempt to adjust which of the granted resources they use for the SL communication with each other.

At steps 606 and 607, the UEs 14A and 14B detect there is still interference on the unlicensed channel (even after performing the IUC procedure at step 605). As mentioned above, if such interference is hidden node interference, it may be detected, for example, based on failed Tx/Rx attempts between the UEs 14A and 14B or by RSSI and/or wideband channel measurements performed on the granted unlicensed SL resources. It may be that only one of the UEs 14A and 14B detects the interference.

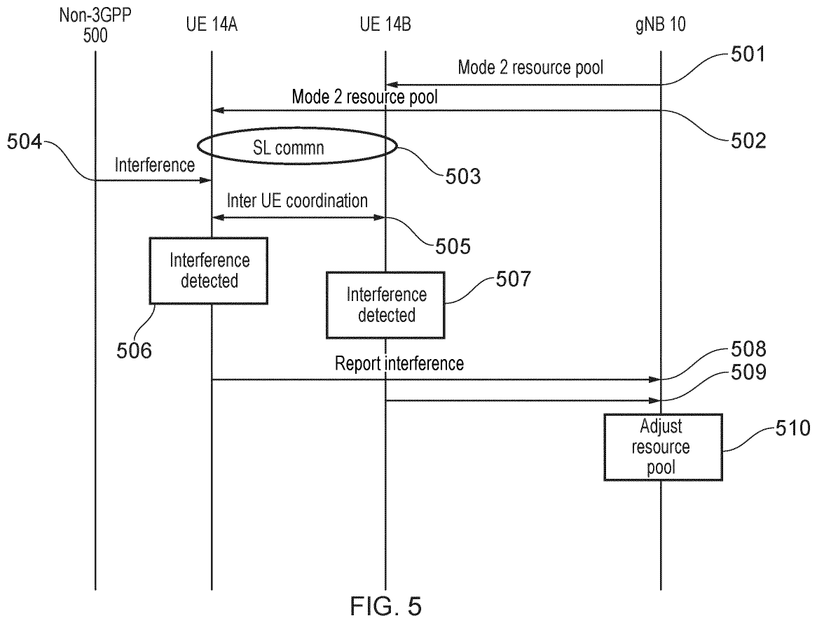

At steps 608 and 609, the UEs 14A and 14B report the detected interference to the gNB 10. It may be that only one of the UEs 14A and 14B reports the interference. As well as the report indicating the occurrence of interference, it may additionally report the interference pattern (e.g. a burst blanking out every 10 ms) and/or source of the interference (Wi-Fi, Bluetooth, GNSS, satellite signal, etc.). It may do this in the same way as described for steps 508 and 509 of FIG. 5 (e.g. using additional transmitter and/or receiver circuitry (not shown)), for example.

As for steps 508 and 509 of FIG. 5, the Tx UE or Rx UE may report interference to the gNB by transmitting reporting information to the gNB. The reporting information may be based on IUC information (which is sent between UEs, e.g. from the Rx UE to the Tx UE, to indicate preferred and/or non-preferred resources). For example, the reporting information may comprise a copy of the IUC information transmitted between the Tx and Rx UEs. The interference reporting information may be transmitted via Layer 1 (L1) and/or medium access control (MAC)/radio resource control (RRC) layer signalling, for example. In particular, the interference reporting information may be comprised in an adapted SidelinkUEInformationNR RRC message, as previously described.

In response to the reported interference at steps 608 and/or 609, at step 610, the gNB adjusts granted resources to address the interference. For example, the gNB may grant different Tx and/or Rx resources to the UE 14A and/or UE 14B in place of the originally granted resources subject to the detected interference.

In a case where mode 2 resource pool(s) for SL communication are pre-configured at a UE, information identifying them may be stored in a subscriber identifier module (SIM) card of the UE, for example. The resource pool(s) may then be adjusted using any suitable mechanism. For example, OMA-DM (Open Mobile Alliance-Device Management) or NAS (Non-Access Stratum) signalling may be used to update the stored SIM card information to identify the adjusted resource pool(s). If necessary, the gNB cooperates with other network entities (e.g. OMA-DM server or core network) in order to do this if it determines resource pool adjustment is necessary.

In a Uu link (that is, for example, the UE to gNB link), a beam-based LBT procedure is being considered for 3GPP Release 17 for frequencies above 52.6 GHZ (e.g. FR2-2). If a UE performs mode 2 sidelink communication on a frequency which is also used for Uu communication (e.g. by the gNB whose cell the UE is located in or a neighbouring gNB), there is a need for any gNB allocating the mode 2 resource pool(s) and/or allocating beam resources to know about any interference caused by interfering beams on the SL communication so that the gNB can take appropriate action. For example, the gNB may change the beam configuration (e.g. the frequencies used by the beam), the SL resource pool configuration (e.g. which resource pool is used or the resources of a given resource pool) or a combination of both.

In an embodiment, UEs experiencing interference from Uu link signals may report this to the gNB (e.g. in the way described above). The beam configuration and/or SL resource pool configuration can then be adjusted accordingly. In an example, the UE may indicate (e.g. in the SidelinkUEInformationNR message) one or more frequencies on which interference is detected to the gNB. If this corresponds to one or more frequencies used in the gNB's beam configuration (or, for example, the beam configuration of one or more neighbouring gNBs), the beam configuration and/or SL resource pool configuration are adjusted so that beam configuration and SL resource pool configuration use different frequencies. This alleviates the interference.

Alternatively, when the resource pool(s) in mode 2 are allocated to UEs by a plurality of gNBs, each gNB may exchange information indicating the beam configuration of and SL resource pool configuration allocated by that gNB with the other gNBs. This allows the gNBs to coordinate with each other to minimise beam and SL interference. For example, the gNBs may coordinate such that the beam resources used by each gNB use different frequencies to the resource pool(s) configured by that gNB and all gNBs immediately neighbouring that gNB.

In another example, in cases in which a UE is configured to select a beam direction with respect to which it is to transmit and/or receive signals to and from a gNB on the Uu link (using licensed resources, in this case), the UE may also report any interference it experiences from SL transmission by another UE. For example, the UE may measure and report, to the gNB, a measurement (e.g. PSSCH-RSRP, SL-RSSI or another measurement such as a signal to noise ratio (SNR)) of such an interference signal detected on resources used by the UE on the Uu link. The measurement may be reported when it exceeds a certain threshold, for example. The UE may also indicate information about the identity of the source of the interference, such as a UE ID of the UE undertaking the SL communication which is causing the interference (if the UE ID can be decoded), whether the interfering signal is an SL Tx/Rx signal or whether the interfering signal is being transmitted by a 3GPP device. This information allows the gNB to determine that there is interference involving SL resources and to adjust those SL resources accordingly.

For example, if a UE ID decoded from the interfering signal is reported, the gNB can quickly determine that the identified UE has been allocated SL resources (via mode 1 or mode 2) and adjust those allocated SL resources to alleviate the interference.

If it is determined that the interfering signal is an SL Tx/Rx signal (but, for example, the UE ID cannot be decoded), the gNB at least knows that a UE in range of the reporting UE and which is configured to perform SL communication is causing the interference. The gNB can then, for example, adjust the SL resources allocated to all UEs in range of the reporting UE (e.g. in the same cell and/or all neighbouring cells) to alleviate the interference. In an example, an SL Tx/Rx signal comprises a characteristic (e.g. an explicit indicator) indicating it is an SL Tx/Rx signal rather than, for example, a Uu link Tx/Rx signal.

If it is determined that the interfering signal is being transmitted by a 3GPP device (but, for example, the UE ID cannot be decoded and it cannot be ascertained that it is an SL Tx/Rx signal which is causing the interference), the gNB at least knows that it may be a UE in range of the reporting UE and which is configured to perform SL communication which is causing the interference. The gNB can then, for example, adjust the SL resources allocated to all UEs in range of the reporting UE (e.g. in the same cell and/or all neighbouring cells). If the interference was truly caused by UE SL communication (which is likely, since communication by a UE on the Uu link (rather than the SL link) usually uses granted resources which are selected to minimise Uu link interference with other UEs in the first place), then the interference should be alleviated. If the interference is not alleviated, then it may be that the interference is coming from another 3GPP source and the gNB may undertake further interference alleviation measures.

In any case, with these examples, any corresponding interference experienced by the UEs performing SL communication will also be alleviated.

Thus, with the present technique, interference experienced by UEs performing sidelink communication using unlicensed resources allocated by either mode 1 or mode 2 may be alleviated by the allocated resources being adjusted by the network. The resource adjustment may involve granting new SL resources to the UEs involved (in mode 1) or adjusting the resource pool(s) used by the UEs involved (in mode 2). The resource pool(s) may be adjusted by, for example, selecting a different one or more resource pool(s) from a predetermined set of resource pool(s) (with each resource pool in the predetermined set comprising a set of resources and having a resource pool ID and resource pool(s) being activated or deactivated for use based on their resource pool ID) or by changing at least a portion of the resources comprised in a given resource pool (so the resource pool with its resource pool ID remains activated but at least some of the resources comprised within that resource pool are changed, e.g. additional resources experiencing less interference are added to the resource pool). The resources in a given resource pool (and, indeed, the resource pool(s) and the resource(s) within each resource pool more generally) may be changed, for example, by the gNB providing to the UE updated system information or dedicated signalling identifying the resource pool(s) and the resource(s) within each resource pool. In another example, the resource pool(s) and the resource(s) within each resource pool may be indicated to the UE by another network entity (e.g. the Access and Mobility Management Function (AMF) or an OMA-DM server). In this case, the other network entity is informed of the resource pool(s) and the resource(s) within each resource pool by the gNB, for example.

Thus, even if interference occurring in sidelink communication between UEs cannot be alleviated by the UEs themselves (e.g. using IUC, which enables different resources within the allocated resources to be used but not the allocated resource themselves to be changed), one or more of the UEs can report the interference to the network (e.g. via a gNB). The network then adjusts the allocated resources themselves to alleviate the interference.

The present technique thus helps reduce interference and provide more reliable UE sidelink communication.

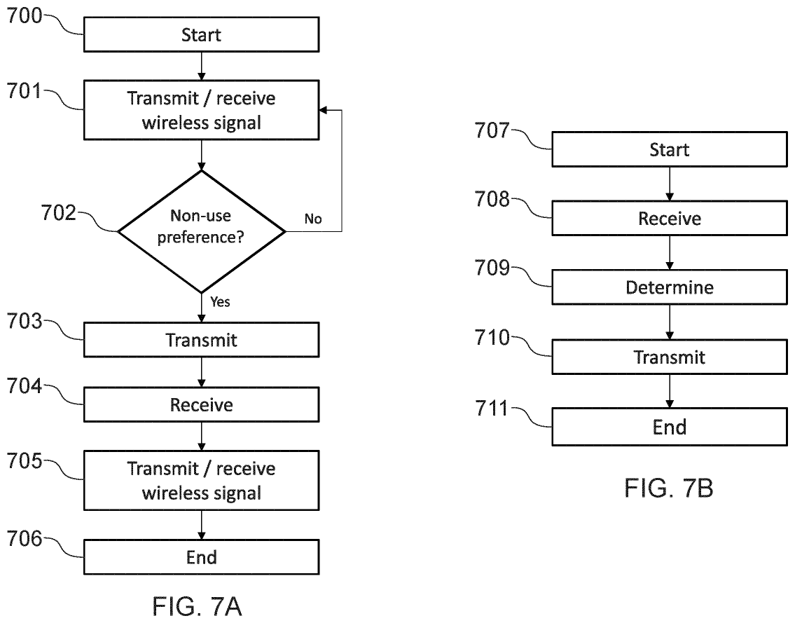

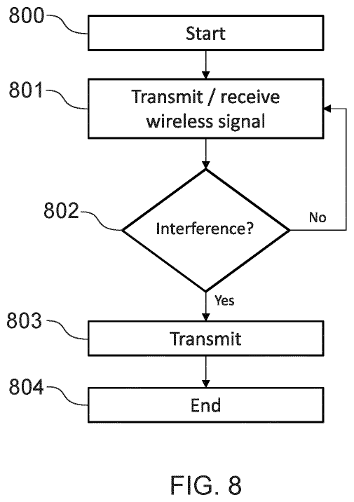

FIGS. 7A, 7B and 8 show methods according to an embodiment.

FIG. 7A shows a method carried out by a wireless telecommunications apparatus (e.g. UE 14) according to an embodiment.

The method starts at step 700.

At step 701, control circuitry (e.g. controller 44) controls communication circuitry (e.g. transmitter 49 and/or receiver 48) to transmit or receive a wireless signal over a sidelink interface using one or more unlicensed resources (e.g. granted unlicensed resources or unlicensed resources is a resource pool).

At step 702, the control circuitry determines whether there is a preference not to use the one or more unlicensed resources. This occurs, for example, if it is determined the one or more unlicensed resources are subject to interference. The control circuitry determines whether there is interference by, for example, determining whether the wireless signal of step 701 is successfully transmitted or received or by performing a measurement (e.g. PSSCH-RSRP, SL-RSSI or another measurement such as a wideband channel measurement or signal to noise ratio (SNR)) on the one or more unlicensed resources. The presence of interference may be determined when the measurement exceeds a certain threshold, for example. The UE may make the interference signal measurement during a predetermined temporal window in which it knows another UE with which it performs sidelink communication (e.g. UE 14B when it is UE 14A carrying out the interference detection) does not make a transmission (and therefore any detected signal on the one or more unlicensed resources must be an interference signal rather than a signal transmitted by the other UE).

If there is no preference not to use the one or more unlicensed resources (e.g. because no interference on the one or more unlicensed resources is detected), the method returns to step 701. If there is a preference not to use the one or more unlicensed resources (e.g. because interference on the one or more unlicensed resources is detected), the method proceeds to step 703.

At step 703, the control circuitry controls the communication circuitry to transmit a signal (e.g. comprised in a SidelinkUEInformationNR RRC message) to the wireless telecommunications network indicating the preference not to use the one or more unlicensed resources.

At step 704, the control circuitry controls the communication circuitry to receive a signal from the wireless telecommunications network indicating one or more different resources to use for transmitting or receiving the wireless signal over the sidelink interface. The one or more different resources are newly granted resources or are comprised in one or more newly activated resource pools (e.g. as identified by one or more respective resource pool IDs), for example.

At step 705, the control circuitry controls the communication circuitry to transmit or receive the wireless signal over the sidelink interface using the one or more different resources.

The method ends at step 706.

It is noted that steps 701 to 703 and steps 704 to 705 may be carried out by different UEs. For example, it may be that UEs 14A and 14B communication via sidelink communication using one or more unlicensed resources. UE 14A detects interference on the one or more unlicensed resources and alerts the gNB 10 that there is therefore a preference not to use the one or more unlicensed resources (as described by steps 701 to 703). In response, the gNB 10 transmits the signal indicating the one or more different resources to the UE 14B, which then performs sidelink communication with the UE 14A using the one or more different resources (as described by steps 704 to 705).

More generally, the signal received from the gNB at step 704 (this being received at either the reporting UE, e.g. UE 14A, or another UE, e.g. UE 14B) may indicate not to use the one or more unlicensed resources. This may be explicit (e.g. by indicating resource pool ID(s) of resource pool(s) which are to be deactivated) or implicit (e.g. by indicating resource pool ID(s) of resource pool(s) which are to be activated, with any resource pool(s) currently being used which are not indicated no longer being used). In response to the signal, different resources (e.g. those of the newly activated resource pool(s) or the remaining resource pool(s) which were not deactivated) are used for sidelink communication.

FIG. 7B shows a method carried out by a wireless telecommunications apparatus (e.g. TRP 10, such as a gNB) according to an embodiment.

The method starts at step 707.

At step 708, control circuitry (e.g. controller 34) controls communication circuitry (e.g. transmitter 30 and/or receiver 32) to receive a signal (e.g. comprised in a SidelinkUEInformationNR RRC message) from a second wireless telecommunications apparatus (e.g. UE 14) indicating there is a preference for the second wireless telecommunications apparatus not to use one or more unlicensed resources (e.g. granted unlicensed resources or unlicensed resources is a resource pool) to transmit or receive a wireless signal over a sidelink interface. This may be because, for example, the one or more unlicensed resources are subject to interference, as previously explained.

At step 709, the control circuitry determines in response to the received signal, one or more different resources for use by the second wireless telecommunications apparatus to transmit or receive the wireless signal over the sidelink interface.

At step 710, the control circuitry controls the communication circuitry to transmit a signal to the second wireless telecommunications apparatus indicating the one or more different resources. The one or more different resources are newly granted resources or are comprised in one or more newly activated resource pools (e.g. as identified by one or more respective resource pool IDs), for example. As previously explained, the signal transmitted at step 710 indicating the one or more different resources may also be sent to a different wireless telecommunications apparatus to the wireless telecommunication apparatus which transmitted the signal at step 708 (e.g. if the UE 14A transmits the signal at step 710, the signal transmitted at step 710 may be transmitted to the UE 14B). The signal, more generally, may indicate, implicitly or explicitly, that the one or more unlicensed resources are not to be used (e.g. through specifying activated or deactivated resource pool ID(s)), as previously described.

The method ends at step 711.

FIG. 8 shows a method carried out by a wireless telecommunications apparatus (e.g. UE 14) according to an embodiment. The UE is, for example, a UE other than UEs 14A and 14B which transmits and receive signals from the network via a Uu interface rather than via a sidelink interface, for example. Like the UEs 14A and 14B, however, the UE will still comprise the same hardware as UE 14.

The method starts at step 800.

At step 801, control circuitry (e.g. controller 44) controls communication circuitry (e.g. transmitter 49 and/or receiver 48) to transmit or receive a wireless signal (e.g. in the physical uplink shared channel (PUSCH) or physical downlink shared channel (PDSCH).

At step 802, the control circuitry determines whether the transmitted or received signal is potentially subject to interference from transmission of a wireless signal by another wireless telecommunications apparatus (e.g. UEs 14A and/or 14B) over a sidelink interface.

For example, an interference signal may be detected based on a measurement (e.g. PSSCH-RSRP, SL-RSSI or another measurement such as a wideband channel measurement or signal to noise ratio (SNR)) performed on resources used by the UE on the Uu link. The presence of an interference signal may be determined when the measurement exceeds a certain threshold, for example. The UE does not necessarily know, however, whether this interference is caused by transmission over a sidelink interface. This is why it is referred to as potential interference from transmission of a wireless signal by another wireless telecommunications apparatus over a sidelink interface. The UE may make the interference signal measurement during a predetermined temporal window in which it knows the gNB does not make a transmission (and therefore any detected signal must be an interference signal rather than a signal from the gNB).

If there is no potential interference from the sidelink communication of another wireless telecommunications apparatus, the method returns to step 801. If there is such potential interference, the method proceeds to step 803.

At step 803, the control circuitry controls the communication circuitry to transmit a signal to the wireless telecommunications network (e.g. to gNB 10) indicating that the transmitted or received signal is potentially subject to interference from transmission of a wireless signal by another wireless telecommunications apparatus over a sidelink interface.

If such information is available, the transmission at step 803 may indicate information about the identity of the source of the interference, such as a UE ID of a UE undertaking the SL communication which is causing the interference (if the UE ID can be decoded), whether the interfering signal is an SL Tx/Rx signal or whether the interfering signal is being transmitted by a 3GPP device (that is, another device of the wireless telecommunications network exemplified in FIG. 1, 2 or 3 rather than another device such as a Wi-Fi or Bluetooth device).

The method ends at step 804.

Embodiment(s) of the present disclosure are defined by the following numbered clauses:
Clause 1. A wireless telecommunications apparatus for use in a wireless telecommunications network, the wireless telecommunications apparatus comprising:
   communication circuitry configured to transmit or receive a wireless signal over a sidelink interface using one or more unlicensed resources; and
   control circuitry configured to:
   determine whether there is a preference not to use the one or more unlicensed resources;
   if there is a preference not to use the one or more unlicensed resources, control the communication circuitry to:
   transmit a signal to the wireless telecommunications network indicating the preference not to use the one or more unlicensed resources.
Clause 2. A wireless telecommunications apparatus according to clause 1, wherein the control circuitry is configured to control the communication circuitry to:
   receive a signal from the wireless telecommunications network indicating one or more different resources to use for transmitting or receiving the wireless signal over the sidelink interface; and
   transmit or receive the wireless signal over the sidelink interface using the one or more different resources.
Clause 3. A wireless telecommunications apparatus according to clause 1 or 2, wherein the control circuitry is configured to determine there is a preference not to use the one or more unlicensed resources when it is determined the one or more unlicensed resources are subject to interference.
Clause 4. A wireless telecommunications apparatus according to clause 3, wherein the control circuitry is configured to determine whether the one or more unlicensed resources are subject to interference during a predetermined time period when there is no communication between the wireless telecommunications apparatus and another wireless telecommunications apparatus over the sidelink interface.
Clause 5. A wireless telecommunications apparatus according to any preceding clause, wherein the one or more unlicensed resources are granted by the wireless telecommunications network.
Clause 6. A wireless telecommunications apparatus according to clause 5, wherein the one or more different resources are granted by the wireless telecommunications network.
Clause 7. A wireless telecommunications apparatus according to any one of clauses 1 to 4, wherein the one or more unlicensed resources are comprised in one or more resource pools allocated to the wireless telecommunications apparatus.
Clause 8. A wireless telecommunications apparatus according to clause 7, wherein the one or more resource pools are allocated to the wireless telecommunications apparatus by the wireless telecommunications network.
Clause 9. A wireless telecommunications apparatus according to clause 7, wherein the one or more resource pools are preconfigured at the wireless telecommunications apparatus.
Clause 10. A wireless telecommunications apparatus according to clause 2, wherein:
   the one or more unlicensed resources are comprised in one or more resource pools allocated to the wireless telecommunications apparatus;
   the one or more different resources are comprised in one or more different resource pools; and
   the signal from the wireless telecommunications network indicating the one or more different resources indicates the one or more different resource pools.
Clause 11. A wireless telecommunications apparatus according to clause 10, wherein:
   the one or more resource pools and the one or more different resource pools are part of a set of resource pools, each resource pool in the set being identifiable by a resource pool identifier; and
   the signal from the wireless telecommunications network indicating the one or more different resource pools indicates the resource pool identifier of each of the one or more different resource pools.
Clause 12. A wireless telecommunications apparatus according to clause 2, wherein:
   the one or more unlicensed resources are comprised in one or more resource pools allocated to the wireless telecommunications apparatus; and
   the one or more different resources are added to the one or more resource pools.
Clause 13. A wireless telecommunications apparatus according to any preceding clause, wherein the control circuitry is configured to:
   control the communication circuitry to transmit or receive the wireless signal over the sidelink interface using the one or more unlicensed resources while the wireless telecommunications apparatus is in a radio resource control, RRC, idle or inactive mode;
   in response to determining there is a preference not to use the one or more unlicensed resources, control the wireless telecommunications apparatus to enter an RRC inactive or connected mode.
Clause 14. A wireless telecommunications apparatus according to any preceding clause, wherein the signal transmitted to the wireless telecommunications network indicating the preference not to use the one or more unlicensed resources is a radio resource control, RRC, message.
Clause 15. A wireless telecommunications apparatus according to clause 14, wherein the RRC message indicates one or more interested frequencies or one or more frequencies associated with the one or more unlicensed resources which there is a preference not to use.
Clause 16. A wireless telecommunications apparatus according to clause 14 or 15, wherein the control circuitry is configured to:
   if there is a preference not to use the one or more unlicensed resources due to the one or more unlicensed resources being subject to interference, determine whether there is a failure in transmitting or receiving the wireless signal over the sidelink interface using the one or more unlicensed resources; and
   if there is a failure, indicating, in the RRC message, interference as a failure reason.
Clause 17. A wireless telecommunications apparatus according to any preceding clause, wherein the control circuitry is configured to determine whether there is a preference not to use the one or more unlicensed resources based on one or more failed transmissions or receptions of a wireless signal over the sidelink interface using the one or more unlicensed resources, a received signal strength indicator, RSSI, measurement performed on the one or more unlicensed resources, a reference signal received power, RSRP, measurement performed on the one or more unlicensed resources or a wideband channel measurement performed on the one or more unlicensed resources.
Clause 18. A wireless telecommunications apparatus for use in a wireless telecommunications network, the wireless telecommunications apparatus comprising:
   communication circuitry configured to transmit or receive a wireless signal over a sidelink interface using one or more unlicensed resources; and
   control circuitry configured to control the communication circuitry to:
   receive a signal from the wireless telecommunications network indicating not to use the one or more resources for transmitting or receiving the wireless signal over the sidelink interface; and
   transmit or receive the wireless signal over the sidelink interface using one or more different resources.
Clause 19. A wireless telecommunications apparatus according to clause 18, wherein:
   the one or more unlicensed resources are comprised in one or more resource pools allocated to the wireless telecommunications apparatus; and
   the signal from the wireless telecommunications network indicating not to use the one or more resources for transmitting or receiving the wireless signal over the sidelink interface indicates the one or more resource pools.
Clause 20. A wireless telecommunications apparatus according to clause 19, wherein:
   the one or more resource pools are part of a set of resource pools, each resource pool in the set being identifiable by a resource pool identifier; and
   the signal from the wireless telecommunications network indicating not to use the one or more resources for transmitting or receiving the wireless signal over the sidelink interface indicates the resource pool identifier of each of the one or more resource pools.
Clause 21. A wireless telecommunications apparatus according to clause 19 or 20, wherein:
   the one or more different resources are comprised in one or more different resource pools; and
   the signal from the wireless telecommunications network indicating not to use the one or more resources for transmitting or receiving the wireless signal over the sidelink interface indicates the one or more different resource pools.
Clause 22 A wireless telecommunications apparatus according to clause 21, wherein:
   the one or more resource pools and the one or more different resource pools are part of a set of resource pools, each resource pool in the set being identifiable by a resource pool identifier; and
   the signal from the wireless telecommunications network indicating not to use the one or more resources for transmitting or receiving the wireless signal over the sidelink interface indicates the resource pool identifier of each of the one or more different resource pools.
Clause 23. A wireless telecommunications apparatus for use in a wireless telecommunications network, the wireless telecommunications apparatus comprising:
   communication circuitry configured to transmit or receive a wireless signal; and
   control circuitry configured to:
   determine whether the transmitted or received signal is potentially subject to interference from transmission of a wireless signal by another wireless telecommunications apparatus over a sidelink interface; and
   if the transmitted or received signal is potentially subject to interference from transmission of a wireless signal by another wireless telecommunications apparatus over a sidelink interface, control the communication circuitry to:
   transmit a signal to the wireless telecommunications network indicating that the transmitted or received signal is potentially subject to interference from transmission of a wireless signal by another wireless telecommunications apparatus over a sidelink interface.
Clause 24. A wireless telecommunications apparatus according to clause 23, wherein the control circuitry is configured to:
   control the communication circuitry to receive an interfering wireless signal; and
   determine that the interfering wireless signal is potentially transmitted by another wireless telecommunications apparatus over a sidelink interface when the interfering wireless signal comprises an identifier of another wireless telecommunications apparatus, a characteristic indicating that the interfering wireless signal is a signal transmitted over a sidelink interface or a characteristic that the interfering wireless signal is a signal transmitted by another wireless telecommunications apparatus of the wireless telecommunications network;
   wherein the signal transmitted to the wireless telecommunications network indicating that the transmitted or received is potentially subject to interference from transmission of a wireless signal by another wireless telecommunications apparatus over a sidelink interface comprises the identifier of the other wireless telecommunications apparatus, an indication that the interfering wireless signal is a signal transmitted over a sidelink interface or an indication that the interfering wireless signal is a signal transmitted by another wireless telecommunications apparatus of the wireless telecommunications network.
Clause 25. A wireless telecommunications apparatus for use in a wireless telecommunications network, the wireless telecommunications apparatus comprising:
   communication circuitry configured to receive a signal from a second wireless telecommunications apparatus indicating there is a preference for the second wireless telecommunications apparatus not to use one or more unlicensed resources to transmit or receive a wireless signal over a sidelink interface; and
   control circuitry configured to:
   determine, in response to the received signal, one or more different resources for use by the second wireless telecommunications apparatus to transmit or receive the wireless signal over the sidelink interface; and
   control the communication circuitry to transmit a signal to the second wireless telecommunications apparatus indicating the one or more different resources.
Clause 26. A wireless telecommunications apparatus according to clause 25, wherein there is a preference for the second wireless telecommunications apparatus not to use the one or more unlicensed resources to transmit or receive the wireless signal over the sidelink interface when the one or more unlicensed resources are subject to interference.
Clause 27. A wireless telecommunications apparatus according to clause 25 or 26, wherein the one or more unlicensed resources are granted by the wireless telecommunications network.
Clause 28. A wireless telecommunications apparatus according to clause 27, wherein the one or more different resources are granted by the wireless telecommunications apparatus.
Clause 29. A wireless telecommunications apparatus according to clause 25 or 26, wherein the one or more unlicensed resources are comprised in one or more resource pools allocated to the second wireless telecommunications apparatus.
Clause 30. A wireless telecommunications apparatus according to clause 29, wherein the one or more resource pools are allocated to the second wireless telecommunications apparatus by the wireless telecommunications network.
Clause 31. A wireless telecommunications apparatus according to clause 30, wherein the one or more resource pools are preconfigured at the second wireless telecommunications apparatus.
Clause 32. A wireless telecommunications apparatus according to any one of clauses 29 to 31, wherein:
   the one or more different resources are comprised in one or more different resource pools; and
   the signal transmitted to the second wireless telecommunications apparatus indicating the one or more different resources indicates the one or more different resource pools.
Clause 33. A wireless telecommunications apparatus according to clause 32, wherein:
   the one or more resource pools and the one or more different resource pools are part of a set of resource pools, each resource pool in the set being identifiable by a resource pool identifier; and
   the signal transmitted to the second wireless telecommunications apparatus indicating the one or more different resource pools indicates the resource pool identifier of each of the one or more different resource pools.
Clause 34. A wireless telecommunications apparatus according to any one of clauses 29 to 31, wherein the one or more different resources are added to the one or more resource pools.
Clause 35. A wireless telecommunications apparatus according to any one of clauses 25 to 34, wherein the signal received from the second wireless telecommunications apparatus indicating preference not to use the one or more unlicensed resources is a radio resource control, RRC, message.
Clause 36. A wireless telecommunications apparatus according to clause 35, wherein the RRC message indicates one or more interested frequencies or one or more frequencies associated with the one or more unlicensed resources which there is a preference not to use.
Clause 37. A wireless telecommunications apparatus according to clause 35 or 36, wherein the RRC message indicates interference as a failure reason when there is a failure of transmission or reception of a wireless signal by the second wireless telecommunications over the sidelink interface using the one or more unlicensed resources and the one or more unlicensed resources are subject to interference.
Clause 38. A wireless telecommunications apparatus according to any one of clauses 25 to 37, wherein the control circuitry is configured to:
   control the communication circuitry to receive a signal from a third wireless telecommunications apparatus indicating that a signal transmitted or received by the third wireless telecommunications apparatus is potentially subject to interference from transmission of a wireless signal by another wireless telecommunications apparatus over a sidelink interface;
   determine, in response to the received signal, one or more different resources for use by the second wireless telecommunications apparatus to transmit or receive the wireless signal over the sidelink interface; and
   control the communication circuitry to transmit a signal to the second wireless telecommunications apparatus indicating the one or more different resources.
Clause 39. A wireless telecommunications apparatus according to clause 38, wherein the signal received from to the third wireless telecommunications apparatus indicates that the signal transmitted or received by the third wireless telecommunications apparatus is potentially subject to interference from transmission of wireless a signal by another wireless telecommunications apparatus over a sidelink interface comprises the identifier of the other wireless telecommunications apparatus, an indication that the interfering wireless signal is a signal transmitted over a sidelink interface or an indication that the interfering wireless signal is a signal transmitted by another wireless telecommunications apparatus of the wireless telecommunications network.
Clause 40. A wireless telecommunications apparatus according to clause 26, wherein, in response to the received signal from the second wireless telecommunications apparatus indicating there is a preference for the second wireless telecommunications apparatus not to use one or more unlicensed resources to transmit or receive a wireless signal over a sidelink interface, the control circuitry is configured to:
   determine whether the interference on the one or more unlicensed resources is associated with a signal transmitted or received by the wireless telecommunications network using a beam transmission, the beam transmission using one or more beam transmission resources;
   if the interference is associated with a signal transmitted or received by the wireless telecommunications network using a beam transmission, control the wireless telecommunications network to reconfigure the beam transmission to use one or more different beam transmission resources.
Clause 41. A method of controlling a wireless telecommunications apparatus for use in a wireless telecommunications network, the method comprising controlling the wireless telecommunications apparatus to:
   transmit or receive a wireless signal over a sidelink interface using one or more unlicensed resources;
   determine whether there is a preference not to use the one or more unlicensed resources; and
   if there is a preference not to use the one or more unlicensed resources:
   transmit a signal to the wireless telecommunications network indicating preference not to use the one or more unlicensed resources.
Clause 42. A method of controlling a wireless telecommunications apparatus for use in a wireless telecommunications network, the method comprising controlling the wireless telecommunications apparatus to:
   transmit or receive a wireless signal over a sidelink interface using one or more unlicensed resources;
   receive a signal from the wireless telecommunications network indicating not to use the one or more resources for transmitting or receiving the wireless signal over the sidelink interface; and
   transmit or receive the wireless signal over the sidelink interface using one or more different resources.
Clause 43. A method of controlling a wireless telecommunications apparatus for use in a wireless telecommunications network, the method comprising controlling the wireless telecommunications apparatus to:
   to transmit or receive a wireless signal; and
   determine whether the transmitted or received signal is potentially subject to interference from transmission of a wireless signal by another wireless telecommunications apparatus over a sidelink interface; and
   if the transmitted or received signal is potentially subject to interference from transmission of a wireless signal by another wireless telecommunications apparatus over a sidelink interface:
   transmit a signal to the wireless telecommunications network indicating that the transmitted or received signal is potentially subject to interference from transmission of a wireless signal by another wireless telecommunications apparatus over a sidelink interface.
Clause 44. A method of controlling a wireless telecommunications apparatus for use in a wireless telecommunications network, the method comprising controlling the wireless telecommunications apparatus to:
   receive a signal from a second wireless telecommunications apparatus indicating there is a preference for the second wireless telecommunications apparatus not to use one or more unlicensed resources to transmit or receive a wireless signal over a sidelink interface;
   determine, in response to the received signal, one or more different resources for use by the second wireless telecommunications apparatus to transmit or receive the wireless signal over the sidelink interface; and
   transmit a signal to the second wireless telecommunications apparatus indicating the one or more different resources.
Clause 45. A program for controlling a computer to perform a method according to any one of clauses 41 to 44.
Clause 46. A storage medium storing a program according to clause 45.

Numerous modifications and variations of the present disclosure are possible in light of the above teachings. It is therefore to be understood that, within the scope of the claims, the disclosure may be practiced otherwise than as specifically described herein.

In so far as embodiments of the disclosure have been described as being implemented, at least in part, by one or more software-controlled information processing apparatuses, it will be appreciated that a machine-readable medium (in particular, a non-transitory machine-readable medium) carrying such software, such as an optical disk, a magnetic disk, semiconductor memory or the like, is also considered to represent an embodiment of the present disclosure. In particular, the present disclosure should be understood to include a non-transitory storage medium comprising code components which cause a computer to perform any of the disclosed method(s).

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more computer processors (e.g. data processors and/or digital signal processors). The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to these embodiments. Additionally, although a feature may appear to be described in connection with particular embodiments, one skilled in the art would recognize that various features of the described embodiments may be combined in any manner suitable to implement the present disclosure.

### REFERENCES

[1] Holma H. and Toskala A, “LTE for UMTS OFDMA and SC-FDMA based radio access”, John Wiley and Sons, 2009.
[2] 3GPP TS 38.215
[3] 3GPP TSG-RAN WG2 Meeting #116bis-e electronic R2-21xxxxx Online, Jan. 17-25, 2022, https://www.3gpp.org/ftp/tsg_ran/WG2_RL2/TSGR2_116bis-e/Inbox/Chairs_Notes/RAN2-116bis-e_Rel17_NR%20SL%20enh_EoM-r1.docx
[4] 3GPP TS 38.331

ANNEX 1
Inter UE coordination agreements

Agreement on resource allocation enhancements RAN2 scopes:

| | |
|---|---|
| 1: | Inter-UE coordination (IUC) issues RAN2 mainly relies on RAN1: |
| | - HARQ retransmission number for inter-UE coordination information |
| | - Information and length of information of IUC MAC CE. The information indicated in RAN1 |
| | LS should be taken into account as baseline. |
| | - UE-B procedure (e.g. final selection of resources) to the (non-)preferred resource set in IUC |
| | - Scheme 2 inter-UE coordination design |
| | - Condition for the UE-A to transmit IUC |
| | - Signaling design and trigger conditions for the request from UE-B to UE-A |
| | - Cast types(UC/GC/BC) of inter-UE coordination |
| | - Transmission of inter-UE coordination MAC CE on dedicated resource |
| | - L1 parameters/configurations for IUC in Uu RRC (including L1 configurations per resource |
| | pool) |
| | - Whether UE-A can be in mode1 or mode2 (interested companies are invited to raise/discuss |
| | the issue directly in RAN1) |
| 2. | IUC issues RAN2 starts discussion: |
| | - LCP for inter-UE coordination MAC CE, support for standalone inter-UE coordination MAC |
| | CE/multiplex MAC CE and MAC SDU in a MAC PDU |
| | - Timer to handle latency bound for inter-UE coordination |
| | - Priority value/priority order of inter-UE coordination MAC CE. RAN1 progress can be taken |
| | into account in phase-2 discussion. |
| | - HARQ feedback option of inter-UE coordination MAC CE |
| 3. | IUC in SL DRX is deprioritized in Rel-17 from RAN2 point of view |

ANNEX 2

SidelinkUEInformationNR
The SidelinkUEinformationNR message is used for the indication of NR sidelink UE information to the network.
Signalling radio bearer: SRB1
RLC-SAP: AM
Logical channel: DCCH
Direction: UE to Network
SidelinkUEInformationNR message
-- ASN1START
-- TAG-SIDELINKUEINFORMATIONNR-START

| | |
|---|---|
| SidelinkUEInformationNR-r16::= | SEQUENCE { |
| criticalExtensions | CHOICE { |
| sidelinkUEInformationNR-r16 | SidelinkUEInformationNR-r16-IEs, |
| criticalExtensionsFuture | SEQUENCE { } |

}
}

| SidelinkUEInformationNR-r16-IEs ::= | SEQUENCE { | |
|---|---|---|
| sl-RxInterestedFreqList-r16 | SL-InterestedFreqList-r16 | OPTIONAL, |
| sl-TxResourceReqList-r16 | SL-TxResourceReqList-r16 | OPTIONAL, |
| sl-FailureList-r16 | SL-FailureList-r16 | OPTIONAL, |
| lateNonCriticalExtension | OCTET STRING | OPTIONAL, |
| nonCriticalExtension | SEQUENCE { } | OPTIONAL |

}

| | |
|---|---|
| SL-InterestedFreqList-r16 ::= | SEQUENCE (SIZE (1..maxNrofFreqSL-r16)) OF INTEGER |

(1..maxNrofFreqSL-r16)

| | |
|---|---|
| SL-TxResourceReqList-r16 ::= | SEQUENCE (SIZE (1..maxNrofSL-Dest-r16)) OF SL- |

TxResourceReq-r16

| | |
|---|---|
| SL-TxResourceReq-r16 ::= | SEQUENCE { |
| sl-DestinationIdentity-r16 | SL-DestinationIdentity-r16, |
| sl-CastType-r16 | ENUMERATED {broadcast, groupcast, unicast, spare1}, |
| sl-RLC-ModeIndicationList-r16 | SEQUENCE (SIZE (1..maxNrofSLRB-r16)) OF SL-RLC- |

ModeIndication-r16 OPTIONAL,

| | |
|---|---|
| sl-QoS-InfoList-r16 | SEQUENCE (SIZE (1..maxNrofSL-QFIsPerDest-r16)) OF SL- |

QoS-Info-r16 OPTIONAL,

| | |
|---|---|
| sl-TypeTxSyncList-r16 | SEQUENCE (SIZE (1..maxNrofFreqSL-r16)) OF SL- |

TypeTxSync-r16 OPTIONAL,

| | |
|---|---|
| sl-TxInterestedFreqList-r16 | SL-TxInterestedFreqList-r16 |

OPTIONAL,
sl-CapabilityInformationSidelink-r16 OCTET STRING
OPTIONAL
}

| | |
|---|---|
| SL-TxInterestedFreqList-r16 ::= | SEQUENCE (SIZE (1..maxNrofFreqSL-r16)) OF INTEGER |

(1..maxNrofFreqSL-r16)

| | |
|---|---|
| SL-QoS-Info-r16 ::= | SEQUENCE { |
| sl-QoS-FlowIdentity-r16 | SL-QoS-FlowIdentity-r16, |
| sl-QoS-Profile-r16 | SL-QoS-Profile-r16 |

OPTIONAL
}

| | |
|---|---|
| SL-RLC-ModeIndication-r16 ::= | SEQUENCE { |
| sl-Mode-r16 | CHOICE { |
| sl-AM-Mode-r16 | NULL, |
| sl-UM-Mode-r16 | NULL |

},

| | |
|---|---|
| sl-QoS-InfoList-r16 | SEQUENCE (SIZE (1..maxNrofSL-QFIsPerDest-r16)) OF SL-QoS- |

Info-r16
}

| | |
|---|---|
| SL-FailureList-r16 ::= | SEQUENCE (SIZE (1..maxNrofSL-Dest-r16)) OF SL-Failure-r16 |
| SL-Failure-r16 ::= | SEQUENCE { |
| sl-DestinationIdentity-r16 | SL-DestinationIdentity-r16, |
| sl-Failure-r16 | ENUMERATED {rlf,configFailure, spare6, spare5, spare4, |

spare3, spare2, spare1}
}
-- TAG-SIDELINKUEINFORMATIONNR-STOP
-- ASN1STOP

SidelinkUEinformationNR field descriptions

sl-RxInterestedFreqList
Indicates the index of frequency on which the UE is interested to receive NR sidelink communication. The value 1
corresponds to the frequency of first entry in sl-FreqInfoList broadcast in SIB12, the value 2 corresponds to the
frequency of second entry in sl-FreqInfoList broadcast in SIB12 and so on. In this release, only value 1 can be
included in the interested frequency list.
sl-TxResourceReq
Paramters to request the transmission resources for NR sidelink communication to the network in the Sidelink UE
Information report.

SL-TxResourceReq field descriptions

sl-CapabilityInformationSidelink
Includes the UECapabilityInformationSidelink message (which can be also included in
ueCapabilityInformationSidelink-r16 in UECapabilityEnquirySidelink from peer UE) received from the peer UE.
sl-CastType
Indicates the cast type for the corresponding destination for which to request the resource.
sl-DestinationIdentity
Indicates the destination for which the TX resource request and allocation from the network are concerned.
sl-QoS-InfoList
Includes the QoS profile of the sidelink QoS flow as specified in TS 23.287 [55]
sl-QoS-FlowIdentity
This identity uniquely identifies one sidelink QoS flow between the UE and the network in the scope of UE, which
is unique for different destination and cast type.
sl-RLC-ModeIndication
This field indicates the RLC mode and optionally the related QoS profiles for the sidelink radio bearer, which has
not been configured by the network and is initiated by another UE in unicast. The RLC mode for one sidelink radio
bearer is aligned between UE and NW by the sl-QoS-FlowIdentity.
sl-TxInterestedFreqList
Each entry of this field indicates the index of frequency on which the UE is interested to transmit NR sidelink
communication. The value 1 corresponds to the frequency of first entry in sl-FreqInfoList broadcast in SIB12, the
value 2 corresponds to the frequency of second entry in sl-FreqInfoList broadcast in SIB12 and so on. In this
release, only value 1 can be included in the interested frequency list. In this release, only one entry can be
included in the list.
sl-TypeTxSyncList
A list of synchronization reference used by the UE. The UE shall include the same number of entries, listed in the
same order, as in sl-TxInterestedFreqList, i.e. one for each carrier frequency included in sl-TxInterestedFreqList.

SL-Failure field descriptions

sl-DestinationIdentity
Indicates the destination for which the SL failure is reporting for unicast.
sl-Failure
Indicates the sidelink failure cause for the sidelink RLF (value rlf) and sidelink AS configuration failure (value
configFailure) for the associated destination for unicast.

ANNEX 3
5.1.23 PSSCH reference signal received power (PSSCH-RSRP)

| | |
|---|---|
| Definition | PSSCH Reference Signal Received Power (PSSCH-RSRP) is defined as the linear average over |
| | the power contributions (in [W]) of the resource elements of the antenna port(s) that carry |
| | demodulation reference signals associated with physical sidelink shared channel (PSSCH), |
| | summed over the antenna ports. |
| | Demodulation reference signals transmitted on antenna ports 1000 and 1001 shall be used for |
| | PSSCH-RSRP determination if two antenna ports are indicated. |
| | For frequency range 1, the reference point for the PSSCH-RSRP shall be the antenna connector |
| | of the UE. For frequency range 2, PSSCH-RSRP shall be measured based on the combined |
| | signal from antenna elements corresponding to a given receiver branch. For frequency range 1 |
| | and 2, if receiver diversity is in use by the UE, the reported PSSCH-RSRP value shall not be |
| | lower than the corresponding PSSCH-RSRP of any of the individual receiver branches. |
| Applicable for | RRC_IDLE intra-frequency, |
| | RRC_IDLE inter-frequency, |
| | RRC_CONNECTED inter-frequency |

NOTE 1:
The power per resource element is determined from the energy received during the useful part of the symbol, excluding the CP.

5.1.25 Sidelink received signal strength indicator (SL RSSI)

| | |
|---|---|
| Definition | Sidelink Received Signal Strength Indicator (SL RSSI) is defined as the linear average of the |
| | total received power (in [W]) observed in the configured sub-channel in OFDM symbols of a slot |
| | configured for PSCCH and PSSCH, starting from the 2^{nd} OFDM symbol. |
| | For frequency range 1, the reference point for the SL RSSI shall be the antenna connector of the |
| | UE. For frequency range 2, SL RSSI shall be measured based on the combined signal from |
| | antenna elements corresponding to a given receiver branch. For frequency range 1 and 2, if |
| | receiver diversity is in use by the UE, the reported SL RSSI value shall not be lower than the |
| | corresponding SL RSSI of any of the individual receiver branches. |
| Applicable for | RRC_IDLE intra-frequency, |
| | RRC_IDLE inter-frequency, |
| | RRC_CONNECTED intra-frequency, |
| | RRC_CONNECTED inter-frequency |

1. A wireless telecommunications apparatus for use in a wireless telecommunications network, the wireless telecommunications apparatus comprising:
communication circuitry configured to transmit or receive a wireless signal over a sidelink interface using one or more unlicensed resources; and
control circuitry configured to:
determine whether there is a preference not to use the one or more unlicensed resources;
if there is a preference not to use the one or more unlicensed resources, control the communication circuitry to:
transmit a signal to the wireless telecommunications network indicating the preference not to use the one or more unlicensed resources.

2. A wireless telecommunications apparatus according to claim 1, wherein the control circuitry is configured to control the communication circuitry to:
receive a signal from the wireless telecommunications network indicating one or more different resources to use for transmitting or receiving the wireless signal over the sidelink interface; and
transmit or receive the wireless signal over the sidelink interface using the one or more different resources.

3. A wireless telecommunications apparatus according to claim 1, wherein the control circuitry is configured to determine there is a preference not to use the one or more unlicensed resources when it is determined the one or more unlicensed resources are subject to interference.

4. A wireless telecommunications apparatus according to claim 3, wherein the control circuitry is configured to determine whether the one or more unlicensed resources are subject to interference during a predetermined time period when there is no communication between the wireless telecommunications apparatus and another wireless telecommunications apparatus over the sidelink interface.

5. A wireless telecommunications apparatus according to claim 1, wherein the one or more unlicensed resources are granted by the wireless telecommunications network.

6. A wireless telecommunications apparatus according to claim 5, wherein the one or more different resources are granted by the wireless telecommunications network.

7. A wireless telecommunications apparatus according to claim 1, wherein the one or more unlicensed resources are comprised in one or more resource pools allocated to the wireless telecommunications apparatus.

8. A wireless telecommunications apparatus according to claim 7, wherein the one or more resource pools are allocated to the wireless telecommunications apparatus by the wireless telecommunications network.

9. A wireless telecommunications apparatus according to claim 7, wherein the one or more resource pools are preconfigured at the wireless telecommunications apparatus.

10. A wireless telecommunications apparatus according to claim 2, wherein:
the one or more unlicensed resources are comprised in one or more resource pools allocated to the wireless telecommunications apparatus;
the one or more different resources are comprised in one or more different resource pools; and
the signal from the wireless telecommunications network indicating the one or more different resources indicates the one or more different resource pools.

11. A wireless telecommunications apparatus according to claim 10, wherein:
the one or more resource pools and the one or more different resource pools are part of a set of resource pools, each resource pool in the set being identifiable by a resource pool identifier; and
the signal from the wireless telecommunications network indicating the one or more different resource pools indicates the resource pool identifier of each of the one or more different resource pools.

12. A wireless telecommunications apparatus according to claim 2, wherein:
the one or more unlicensed resources are comprised in one or more resource pools allocated to the wireless telecommunications apparatus; and
the one or more different resources are added to the one or more resource pools.

13. A wireless telecommunications apparatus according to claim 1, wherein the control circuitry is configured to:
control the communication circuitry to transmit or receive the wireless signal over the sidelink interface using the one or more unlicensed resources while the wireless telecommunications apparatus is in a radio resource control, RRC, idle or inactive mode;
in response to determining there is a preference not to use the one or more unlicensed resources, control the wireless telecommunications apparatus to enter an RRC inactive or connected mode.

14. A wireless telecommunications apparatus according to claim 1, wherein the signal transmitted to the wireless telecommunications network indicating the preference not to use the one or more unlicensed resources is a radio resource control, RRC, message.

15. A wireless telecommunications apparatus according to claim 14, wherein the RRC message indicates one or more interested frequencies or one or more frequencies associated with the one or more unlicensed resources which there is a preference not to use.

16. A wireless telecommunications apparatus according to claim 14, wherein the control circuitry is configured to:
if there is a preference not to use the one or more unlicensed resources due to the one or more unlicensed resources being subject to interference, determine whether there is a failure in transmitting or receiving the wireless signal over the sidelink interface using the one or more unlicensed resources; and
if there is a failure, indicating, in the RRC message, interference as a failure reason.

17. A wireless telecommunications apparatus according to claim 1, wherein the control circuitry is configured to determine whether there is a preference not to use the one or more unlicensed resources based on one or more failed transmissions or receptions of a wireless signal over the sidelink interface using the one or more unlicensed resources, a received signal strength indicator, RSSI, measurement performed on the one or more unlicensed resources, a reference signal received power, RSRP, measurement performed on the one or more unlicensed resources or a wideband channel measurement performed on the one or more unlicensed resources.

18. A wireless telecommunications apparatus for use in a wireless telecommunications network, the wireless telecommunications apparatus comprising:
communication circuitry configured to transmit or receive a wireless signal over a sidelink interface using one or more unlicensed resources; and
control circuitry configured to control the communication circuitry to:
receive a signal from the wireless telecommunications network indicating not to use the one or more resources for transmitting or receiving the wireless signal over the sidelink interface; and
transmit or receive the wireless signal over the sidelink interface using one or more different resources.

19.-24. (canceled)

25. A wireless telecommunications apparatus for use in a wireless telecommunications network, the wireless telecommunications apparatus comprising:
communication circuitry configured to receive a signal from a second wireless telecommunications apparatus indicating there is a preference for the second wireless telecommunications apparatus not to use one or more unlicensed resources to transmit or receive a wireless signal over a sidelink interface; and
control circuitry configured to:
determine, in response to the received signal, one or more different resources for use by the second wireless telecommunications apparatus to transmit or receive the wireless signal over the sidelink interface; and
control the communication circuitry to transmit a signal to the second wireless telecommunications apparatus indicating the one or more different resources.

26.-46. (canceled)
